(19) United States
(12) Patent Application Publication
(10) Pub. No.: US 2015/0014614 A1
(43) Pub. Date: Jan. 15, 2015

(54) APPARATUS FOR ANCHORING AN OFFSHORE VESSEL

(71) Applicant: SCANA Offshore Vestby AS, Vestby (NO)

(72) Inventors: Torkjell Lisland, Drobak (NO); Torbjørn Mollatt, Oppegard (NO); Alf Reidar Sandstad, Arendal (NO)

(21) Appl. No.: 14/382,969

(22) PCT Filed: Mar. 7, 2013
(86) PCT No.: PCT/EP2013/054593

§ 371 Date: Sep. 4, 2014

(30) Foreign Application Priority Data
Mar. 7, 2012 (NO) 20120264

(51) Int. Cl. B66D 1/72; B63B 21/18; B63B 21/16; B66D 5/16

(52) U.S. Cl. CPC B66D 1/72; B66D 5/16; B63B 21/18; B63B 21/16
USPC 254/325; 254/334

(57) ABSTRACT

An apparatus for anchoring a floating off-shore unit or other type of floating vessel, comprising a rotatably mounted chain sprocket wheel (3) having a chain (3a) secured on its outer periphery, The wheel (3) being arranged to be rotated by reciprocating movement of at least two hydraulic cylinders (1, 2). Each of the cylinders (1, 2) is provided with a locking arm (6, 7) for releasably and mechanically engaging a portion of the wheel (3) in order to rotate the wheel (3) during movement of the respective cylinders (1, 2). Also described is a chain stopper comprising at least four blocks (8) that are hinged at their first ends and at their second ends have a surface that is adapted to engage a chain link The blocks (8) are mounted in opposite pairs.

### FIELD OF THE INVENTION

The present invention in general, relates to an apparatus for anchoring an off-shore floating unit to the sea bed.

Particularly, the present invention relates to a technology for anchoring a floating off-shore unit on the sea bed applying a very simple construction, which is also technically effective.

More particularly, the present invention relates to an apparatus according to the preamble of claim 1. It also relates to a chain stopper according to the preamble of subsequent claim 9.

### TECHNICAL BACKGROUND OF THE INVENTION

In off-shore operations such as oil and gas explorations and productions, anchoring of floating units on the sea bed is very common. Such off-shore units may be oil-drilling and production units such as off-shore platforms, off-shore barges, semi-submersible vessels and so on.

It is also known that such off-shore units are anchored to the sea bed using traction means such as cables or chains. While anchoring, the cables or chains are tightened by rotation of a holding device such as a sprocket wheel, by which the cable or chain is moved securely without slippage. The rotation of the sprocket wheel may be effected by a reciprocating cylinder, coupled to a pawl, as shown in EP 1213255. In this device the single cylinder attacks a chain link by pushing at the lower U-bend thereof. Between each push of the cylinder, the chain will be retained by a chain stopper and no pulling-in of the chain can take place while the piston rod is retracted into the cylinder and made ready for another thrust. Consequently, the pulling-in of the chain will take a substantial amount of time.

There exists a desire in off-shore operations for faster operation to anchor the unit to the sea bed. There is also a requirement to be able to adjust the tension or the length of chain or cable according to shifting conditions at the sea or a desire to move the floating unit somewhat while being anchored. Simultaneously, there is also a requirement to release the chain or cables, which ties an off-shore unit to the sea bed, within a shortened time. This release is required; for example, to change the location of the off-shore unit, e.g., in the event of an emergency such as undesired escape of gas.

The known arrangement as described above, does not teach how the arrangement can effect a quick anchoring operation by tightening the chains or cables. It also, does not teach how release of chains or cables can be done in a controlled manner.

WO 2011/091995, attempts to solve the problem as stated in the preceding paragraph. It discloses two drive pulleys coupled to a chain wheel. The chain, which is the traction means, is intermeshed with the chain wheel. Rotation of the drive pulleys causes rotation of the chain wheel and thus linear motion of the chain. A locking element in the form of a friction band is provided on the outer periphery of each of the drive pulleys. These locking elements interact with driving levers and reciprocating pistons, for creating a pushing action along the circumference of the drive pulleys. Thus, the device may facilitate fast rotation of the drive pulleys. These locking elements are also used as a brake on the drive pulleys, by sliding the free ends of the locking elements towards each other, along the outer periphery of the drive pulleys.

The prior art referred to in the preceding paragraph does teach use of an element which facilitates both fast movement of the chain to tighten it up and also stopping of the chain movement as required, after it has been released. However, it is primarily dependent on application of frictional force for both actions. In off-shore operations, this technology is prone to failure both during moving and braking operation, due to interference of oil and water on the drive pulleys, causing substantial loss of friction on the surface.

Hence, even if the locking elements are applied on the drive pulleys to stop the chain wheel, the latter might rotate due to loss of friction and hence locking elements may fail to effect braking action. Thus, after releasing, the chain might not stop rotating when brakes are applied. Like wise, while tightening also, there might be slippage in each stroke. Furthermore, the arrangement involves cumbersome units which are also prone to substantial wear due to the friction and will have to be replaced frequently.

Hence, there is a need for an apparatus for anchoring, e.g., an off-shore unit to the sea bed, which is capable of ensuring fast rotation of a traction means and is also able to release and arrest the motion of the traction means, in a very simple and technically reliable manner.

The present invention meets the above mentioned needs and other associated needs by providing an apparatus for anchoring an off-shore unit or other floating vessel to the sea bed, the apparatus having at least two drive units for rotating and stopping a holding device on which a traction means is secured. The drive units are coupled with gripping arms which can engage and disengage with the holding device.

### OBJECTS OF THE INVENTION

It is the prime object of the present invention to provide an apparatus for anchoring an off-shore unit or other type of floating vessel to the sea bed, which has a simple and technically effective arrangement for fast movement of a traction means, in order to tighten it up and also for controlled slacking of the traction means.

It is another object of the present invention to provide an apparatus for anchoring an off-shore unit or other type of floating vessel to the sea bed, which does not involve cumbersome features and is substantially quicker than known apparatuses.

It is a further object of the present invention to provide an apparatus for anchoring an off-shore unit or other type of floating vessel to the sea bed, which removes the requirement of friction pads for rotating or stopping the traction means.

All through the specification including the claims, the words “vessels”, “off-shore units”, “fastening”, “anchoring”, “drive devices”, “chains”, “cables”, “sprocket wheels”, “gripping means”, “locking arms”, “piston rods”, “notches”, “swiveling”, “bearing”, “axle”, are to be interpreted in the broadest sense of the respective terms and includes all similar items in the field known by other terms, as may be clear to persons skilled in the art. Restriction/limitation, if any, referred to in the specification, is solely by way of example and understanding the present invention.

### SUMMARY OF THE INVENTION

One or more of the above objects are achieved in an apparatus of the type defined above by providing each of said drive devices with a locking means for releasable and mechanical locking engagement with a portion of the holding device in order to rotate the holding device during movement of the respective drive devices. By mechanical locking engagement is meant an engagement that does not depend on friction, but on positive locking between the drive device and the holding device. Thereby secure and positive force transfer between the drive devices and the holding device is secured, while also providing the possibility of an almost continuous rotation of the holding device.

In a preferred embodiment the locking means comprises a swiveling arm, a first end of which is engaged with a top end of the drive device and a second end of which is rotatable about a common axis with the holding device and a locking arm, a first end of which is engaged with the drive device or the swiveling arm, and a second end of which is adapted to engage with one of a multiple of notches or protrusions of the holding device. Thereby a secure and quick engagement and disengagement of the locking means with the holding device is ensured.

In a further embodiment the second end of each arm is engaged with a bearing arrangement mounted on uprights, which bearing arrangement also carries the holding device in a rotatable manner. Thereby it is ensured that the locking arm rotates about the same axis as the holding device and thereby also a simple mechanical movement of the two parts together.

In a further embodiment the notches or protrusions are located on the outer periphery or an inner periphery of the holding device. This provides a convenient engagement between the moving parts.

In a still further embodiment the locking arms are equipped with a respective hydraulic cylinder having a piston rod, which can be extended and retracted to bring the locking arm into or out of engagement with the notches or protrusions. Thereby is ensured that the locking arm can be brought into and out of engagement with the holding device as required.

In a yet further embodiment the holding device is a sprocket wheel having a geometry for tightly securing along its outer periphery the traction means in the form of a chain.

In yet another embodiment the drive devices are hydraulic cylinders provided with piston rods which can extend and retract by hydraulic means.

Preferably, the hydraulic cylinders are arranged to operate both in series and in parallel for rotation of the sprocket wheel and one or more chain stoppers are provided near a base of the apparatus, for selectively locking and releasing the chain. Thereby the operator has the choice of using the two cylinders alternatingly for fast rotation or in parallel for greater pulling force.

In another aspect of the invention is provided a chain stopper for preventing a chain from moving downward, wherein the chain stopper comprises at least four blocks that are hinged at their first ends and at their second ends have a surface that is adapted to engage a chain link, and where the blocks are mounted in opposite pairs. Thereby is ensured that the chain stopper always will engage with the closest link above the blocks and that a minimum of chain length will pass the chain stopper before it engages with the chain.

In an embodiment of the chain stopper the blocks are situated at a spacing of about 90°, so that the pair of opposite blocks that are immediately below a chain link that lies in substantially the same plane as the blocks will be engaged by the blocks. This further ensures that two blocks will engage the chain link when the chain stopper is brought into engagement.

### BRIEF DESCRIPTION OF THE DRAWINGS

Having described the main features of the invention above, a more detailed and non-limiting description of two exemplary embodiments will follow, with reference to the enclosed drawings.

FIG. 1 is a perspective view of a first embodiment of the apparatus according to the present invention.

FIG. 2 is a side view of the apparatus as shown in FIG. 1.

FIG. 3 is a front view of the apparatus as shown in FIG. 1.

FIG. 4 is a top view of the apparatus as shown in FIG. 1.

FIG. 5 is a perspective view of a second and preferred embodiment of the apparatus according to the present invention.

FIG. 6 is a side view of the apparatus as shown in FIG. 5

FIG. 7 is another side view of the apparatus at a stage of operation which is subsequent to what is shown in FIG. 6.

### DETAILED DESCRIPTION OF THE INVENTION

The following describes two embodiments of the present invention which are purely exemplary for the sake of understanding the invention and non-limiting.

In all the figures, like reference numerals represent like features. Further, when in the following it is referred to “top”, “bottom”, “upward”, “downward”, “above” or “below”, “right hand side ” or “left hand side” and similar terms, this is strictly referring to an orientation with reference to the sea bed, where the sea bed is considered to be horizontal and at the bottom, or to the sea surface, which is considered to substantially parallel to the seabed.

It should also be understood that the orientation of the various components may be otherwise than shown in the drawings without deviating from the principle of the invention. Furthermore, the disposition of off-shore units or floating vessels and related units are not shown, as those are not consequential to the present invention and should be understood by persons skilled in the art.

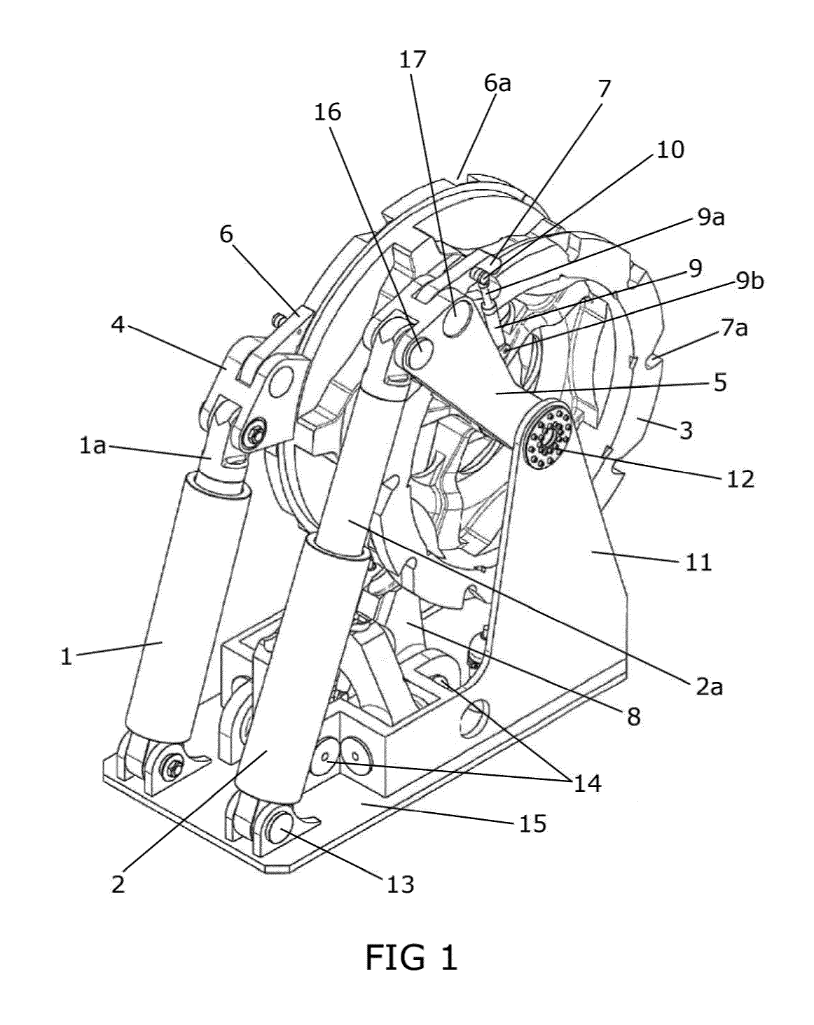

FIG. 1 is a perspective view of one preferred embodiment of the apparatus according to the present invention. The apparatus may be fixed on the deck or elsewhere on the floating unit or other type of floating vessel. The apparatus has a wheel 3 mounted on uprights 11 fixed on a flat base 15. The base 15 is secured to the floating unit or vessel. The wheel can rotate by virtue of a bearing arrangement 12, the front portion of which is shown. This is preferably a stationary axle arrangement.

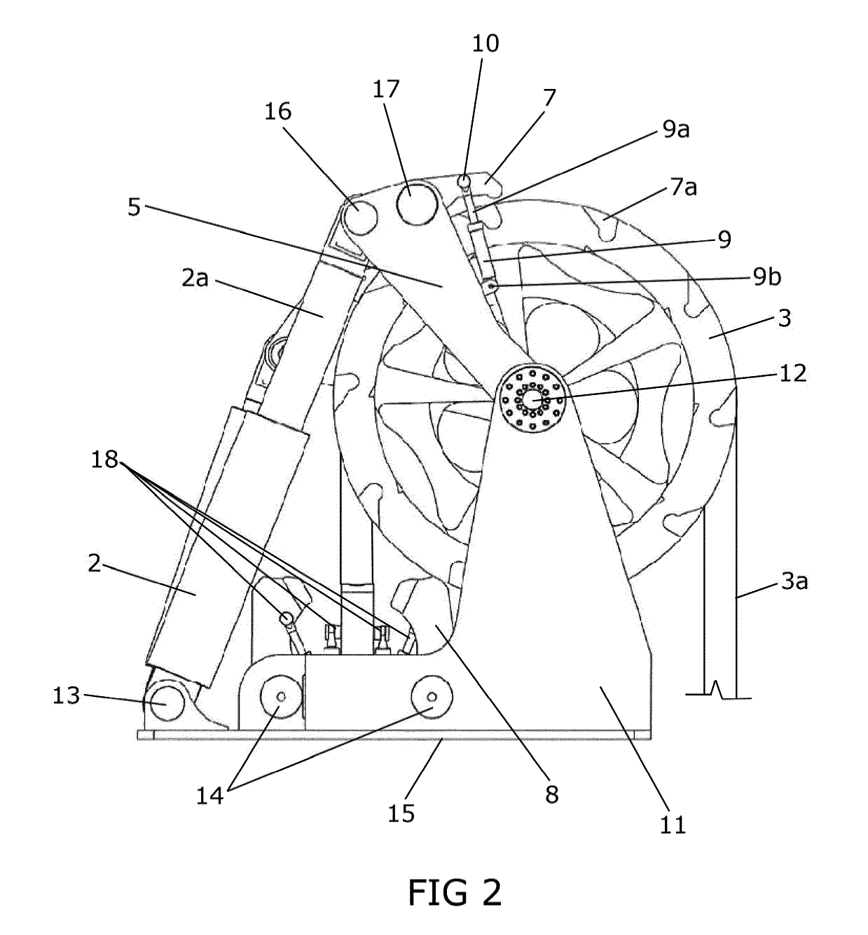

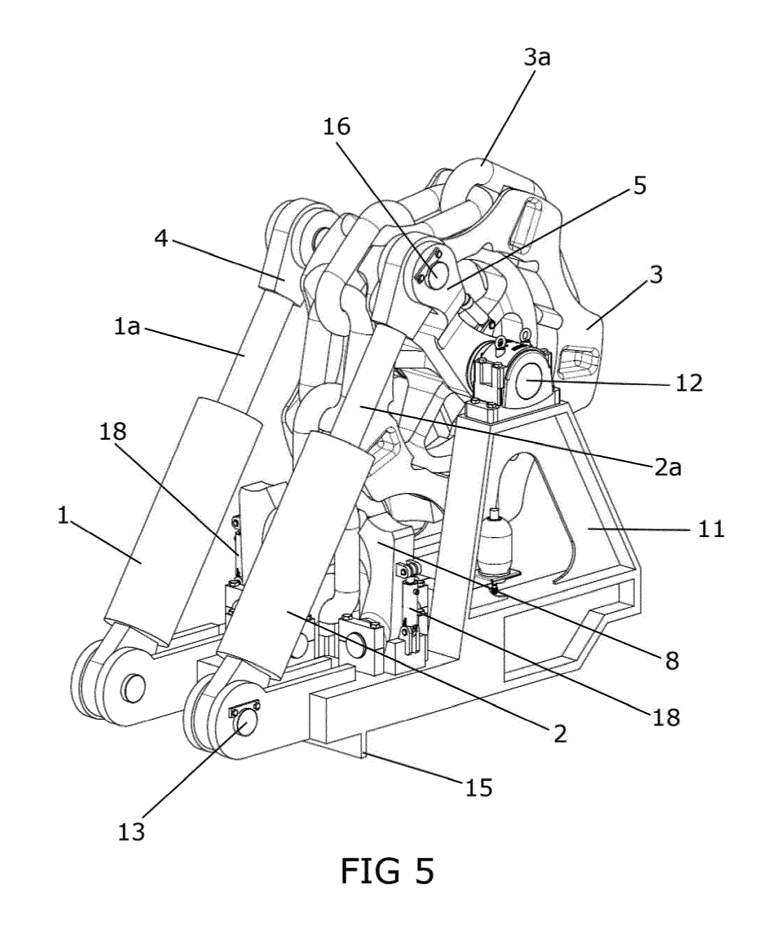

A traction means, which in this case is a chain 3a (best shown in FIGS. 2 and 5) runs over the wheel 3 with a positive engagement that prevents any slippage and ensures that with the rotation of wheel 3, the chain 3a moves proportionately a linear distance. The wheel 3 is coupled with at least two hydraulic cylinders 1, 2.

The hydraulic cylinders 1, 2 have piston rods 1a, 2a, the ends of which are attached to swiveling arms 4, 5 These arms 4, 5 have left hand right hand configuration and three pivot points on each. One pivot point is connected to the piston rods 1a, 2a through pins 16 with bearing arrangement.

Another pivot point is connected to the central axis of wheel 3, through bearing arrangement 12. The third pivot point is connected to locking arms 6, 7 through pins 17 with bearing arrangement. The piston rods 1a, 2a can protrude telescopically out from or retract in to the hydraulic cylinders 1, 2.

The swiveling arms 4, 5 having pivot connections with locking arms 6, 7, can engage and disengage with corresponding notches 6a, 7a on the periphery of the wheel 3. The locking arms 6, 7 are operated by hydraulic cylinders 9, in order to disengage the locking arms 6, 7 from the notches when it is desired to let the wheel run freely. The piston rods 9a of the hydraulic cylinders 9 are connected to locking arms 6, 7 by a bearing joint with pins 10. The piston rods 9a of the hydraulic cylinders 9 move in and out by application of hydraulic pressure.

The other ends of the hydraulic cylinders 9 are connected by pivot joints to a point 9b on the swiveling arm 4, 5. Thus with application of hydraulic pressure as piston rod 9a moves in and out, locking arms 6, 7 engages and disengages on notches 6a,7a on the periphery of wheel 3. These portions are explained in detail later while explaining the functioning of the apparatus.

In the embodiment shown in FIG. 1, the apparatus rests on a basal platform 15. The two bottom ends of the hydraulic cylinders 1, 2 are fixed on the platform through pivot joints and pins 13. Hinge joints 14 for the chain lock are also shown in FIG. 1, but will be explained in detail later.

FIG. 2 is a side view of the apparatus shown in FIG. 1. It clearly shows the configuration of the cylinders 9, supporting the locking arms 6, 7. The locking arm 7 is attached to swiveling arm 4, 5 close to the top end of the piston rod 9a by means of a bearing joint with pin 17. This is also true for the other locking arm 6 on the other arm 4, as shown in FIG. 1.

FIG. 2 also shows the pin 16 with bearings, by means of which the swiveling arm 5 is connected to the top end of the piston rod 2a. Likewise, when FIG. 1 is referred to, it would be clear that this pin with bearing 16 also connect the swiveling arm 4 at the top end of piston rod 1a.

FIG. 2 also shows existence of chain stoppers 8, which acts as a lock for the chain 3a and the wheel 3, to prevent the chain from traveling downwards. Hydraulic cylinders 18 are also shown in FIG. 2. How these function, is explained later.

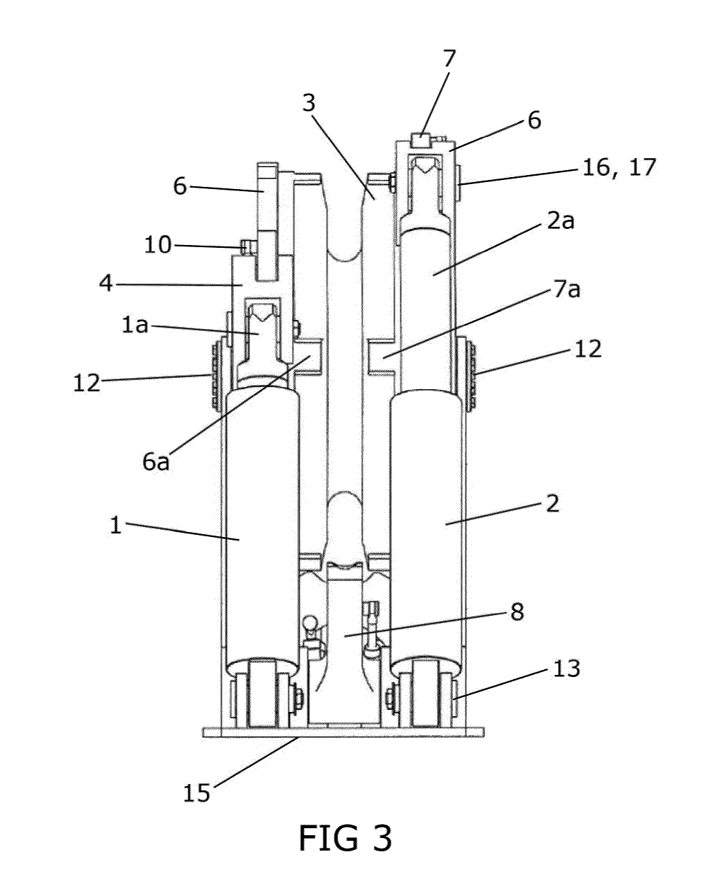

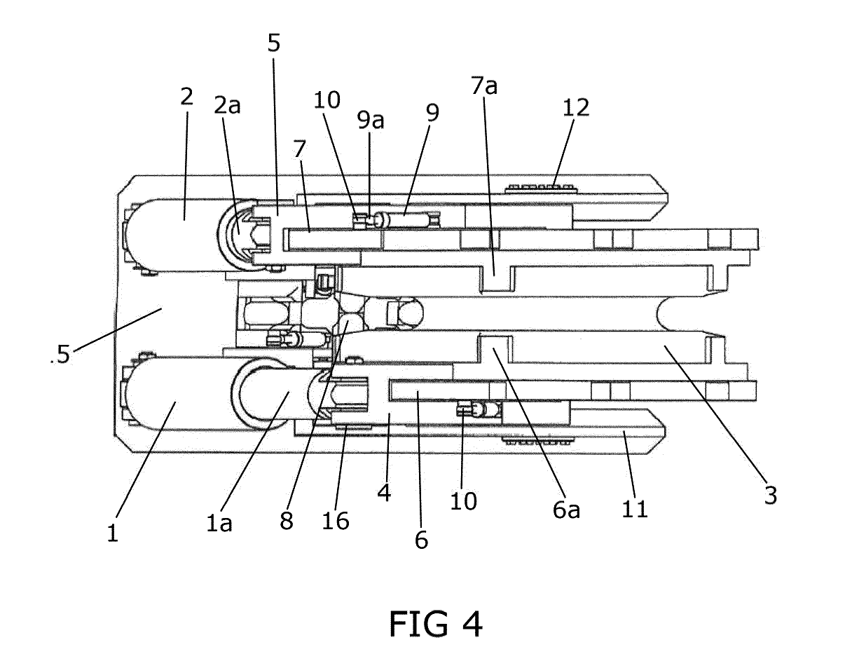

FIG. 3 is a front view of the apparatus shown in FIG. 1 while FIG. 4 is a top view of the same. These figures also show the configuration of the axles 12 at both sides of the wheel 3 and the hydraulic cylinders 1, 2 and its associated features on both sides of the wheel 3.

When FIGS. 1, 2 and 3 are seen together it would be clear, that identical features exist on either side of the wheel 3, which are mirror images. Hence what is shown in FIG. 2 should be identical with the other side of the apparatus.

FIG. 5 is another and preferred embodiment of the apparatus according to the present invention. Most of the features which have been described hereinbefore with reference to FIG. 1 are not explained again, which are essentially represented by like reference numerals. Only the differences are elaborated here.

The traction means here is a chain 3a fixed on a sprocket wheel 3 so that it can rotate with the rotation of the sprocket wheel 3. The toothed portions of the sprocket wheel 3 engages with the chain links 3a for that purpose and ensures that there is no slippage between the wheel 3 and chain 3a.

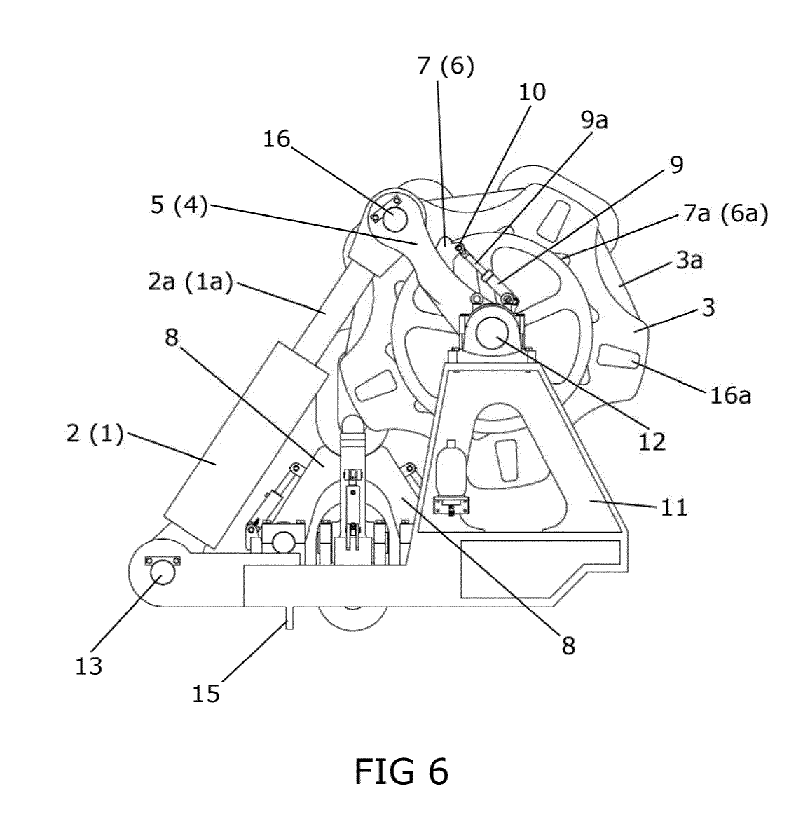

FIG. 6 is a side view of the embodiment shown in FIG. 5. The features shown are present on either side of the sprocket wheel 3 and there is a symmetrical arrangement. An inner circumferential surface of the sprocket wheel 3, on either side of it, is provided with notches 7a (6a on the other side). This is in contrast to the embodiment in FIG. 1 where these notches are present along the outer circumferential surface of the wheel 3.

The locking arm 7 (6 on the other side) engage or disengage with the notches 7a (6a on the other side). Further, the top ends of the piston rods 1a, 2a are connected to the swiveling arms 4, 5 by means of a single bearing arrangement with pin 16.

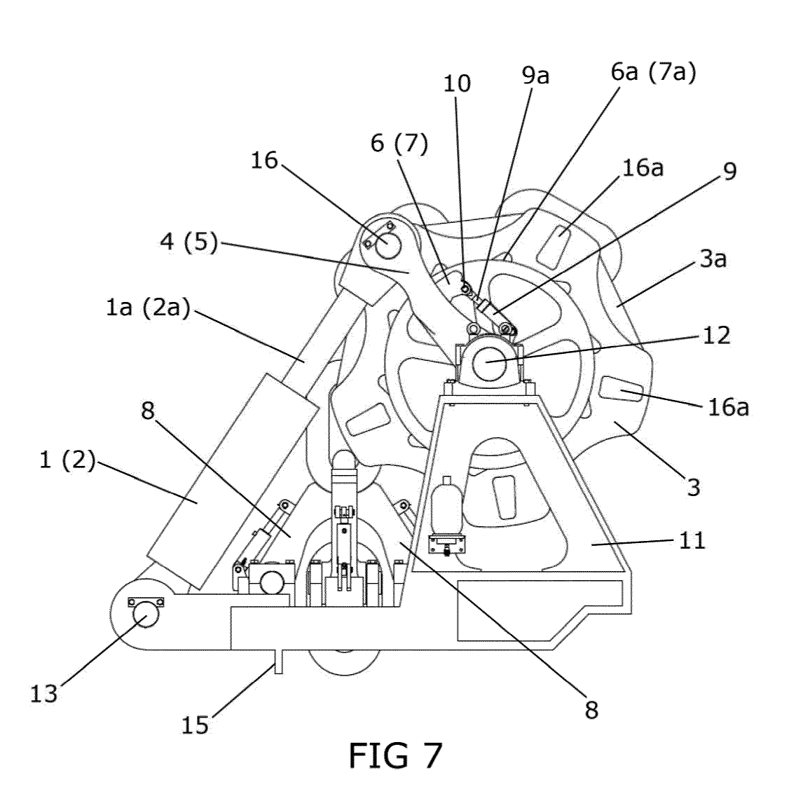

FIG. 7 is a view of a stage which is subsequent to what is shown in FIG. 6.

All the above figures are again referred to while explaining the functioning of the apparatus of the present invention.

Referring to FIG. 1, the hydraulic cylinders 1, 2 are operating in series when the tension in the chain 3a is low. To be precise, the hydraulic cylinders 1, 2 are operating alternately, that is one at a time. The piston rod 2a of the hydraulic cylinder 2 has extended to the maximum. It has reached the end of its stroke in extension. At this point of time, the other piston 1a has retracted inside the cylinder 1.

Now, during extension, as would be particularly clear from FIG. 2, the locking arm 7 on the swiveling arm 5 engages with the notch 7a for pushing against the wheel 3 and causing it to rotate about the bearing 12, in a clockwise direction when seen in FIG. 2. The chain stopper 8 has opened for allowing passage of the chain 3a and movement of the wheel 3. For that purpose the chain stopper has four blocks 8 that rotatable about hinge joints 14 and that are operated by four small hydraulic cylinders 18. The blocks 8 are spaced 90° apart and operate in pairs. That is, only one pair of blocks positioned at 180° to each other, operates at a time, depending upon the position of the chain link that can be locked.

Once the maximum extension of the piston 2a is achieved, one pair of blocks 8 close to lock the chain 3a in position. Then the piston rod 9a connected to locking arm 7 extends to the maximum and the locking arm 7 disengages from the notch 7a to which it was engaged. This stage is shown in FIG. 2. The piston rod 2a now retracts back into the cylinder 2 initiating a downward movement of the swiveling arm 5. During this downward movement of arm 5, the wheel 3 is free from contact with the sub-assembly represented by 2, 2a, 5, 16, 17, 7 and so on, as described hereinbefore. When the piston 2a has retracted to its maximum possible extent inside the cylinder 2, piston rod 9a retracts inside cylinder 9 and firmly engages the matching contour of locking arm 7 with a notch 7a on the wheel 3. According to the invention the blocks 8 will, for safety reason, lock the chain 3a each time cylinder 1 or 2 reaches end of stroke. Without this locking, the chain 3a may slide out uncontrollably under its own weight if the operating cylinder should fail or if an unexpected tension in the chain occurs.

Now the entire time piston 2a was retracting from its maximum extended position, simultaneously, on the other side of the sprocket wheel 3, the piston 1a starts extending out of the cylinder 1. Now, the piston rod 9a attached to swiveling arm 4 is retracted to ensure that the locking arm 6 is engaged with one of the notches 6a. So, as the piston rod 1a and consequently the swiveling arm 4 pushes up, rotational force is provided on the wheel 3 by the swiveling arm 4 for rotating it and the chain 3a. The piston 1a pushes up to the maximum extended position and thereafter functioning takes place exactly in the same manner as explained in the preceding paragraph and this process is repeated as long as it is required.

It is also possible to use the cylinders 1, 2 to perform a slow and controlled feeding out of the chain. In this situation the cylinders are operated in the opposite sense, i.e. the locking arms are in engagement with the wheel when the piston rods 1a, 2a are retracted.

It is possible to let the wheel run freely, e.g., at the start of the dropping the anchor. Then the wheel 3 is not locked by blocks 8 or locking arms 6 or 7, and the chain 3a starts running out under its own weight. This is the release condition of the chain 3a, and the blocks 8 will have to be engaged to stop movement of the chain 3a.

The operation of pulling the chain and releasing the chain may be explained in a nutshell as follows with reference to the FIGS. 1 to 4:

### Pulling the Chain

a) At the beginning of the process, one pair of blocks 8 is closed and holding the chain 3a stationary. The wheel 3 being coupled with chain 3a also remains stationary. Both the cylinders 1 and 2 are fully retracted and the cylinders 9 attached to the locking arms 6 & 7 are fully extended so that they are fully disengaged from the notches 6a & 7a.

b) The piston rod 9a connected to the swiveling arm 6 retracts and firmly engages the matching contour of locking arm 6 with a notch 6a on wheel 3.

c) The blocks 8 that are closed are shaped so that when the chain 3a is pulled, the blocks 8 will be forced outward to let the chain pass. The chain 3a can now move when the wheel 3 rotates.

d) The piston rod 1a extends and being locked with wheel 3 through the locking arm 6, it pushes the wheel 3 which rotates and pulls the chain 3a along with it in the clockwise direction.

e) After the piston rod 1a reaches full extension, the piston rod 9a attached to locking arm 7 retracts, and firmly engages the matching contour of the locking arm 7 with a notch 7a on the wheel 3 and simultaneously, the piston rod 9a connected to locking arm 6 extends fully and disengages the matching contour of the rocking arm 6 from the notch 6a on wheel 3. Alternatively, the locking arm 6 may be forced out of engagement by the wheel, against the hydraulic force of the cylinder 9, when the piston rod 1a retracts, in the same way as a ratchet and pawl mechanism.

f) Now, piston rod 2a extends and being locked with the wheel 3 through the locking arm 7, it pushes the wheel 3 which rotates and pulls the chain 3a along with it in the clockwise direction.

g) After the piston rod 2a reaches full extension, the piston rod 9a attached to the locking arm 6 retracts and firmly engages the matching contour of the locking arm 6 with a notch 6a on the wheel 3 and simultaneously, the piston rod 9a connected to the locking arm 7 extends fully and disengages the matching contour of the locking arm 7 from the notch 7a on the wheel 3.

h) Thus the cycle continues pulling the chain 3a upwards.

### Releasing the Chain

To release the chain in a non-controlled fashion, the following procedure is followed:

a) The piston rods 9a attached to the locking arms 6 and 7 are fully retracted so that the locking arms 6 and 7 are completely disengaged from their respective notches 6a and 7a.

b) The pair of blocks 8 that were closed and holding the chain 3a are now released by operating cylinders 18 and the chain 3a starts moving downwards under its own weight.

c) When the desired length of chain 3a has been released, cylinders 18 are operated again to close and lock the chain 3a in position.

Thus, during pulling of the chain 3a, the wheel 3 rotates at double the speed than what would have been possible with a single cylinder. This is possible by alternate movement of cylinders 1, 2 so that their retraction time is not lost, as compared to using only one cylinder.

It should be understood that if the tension on the chain 3a is very high both the piston rods 1a, 2a, can move up and down simultaneously, thus doubling the load carrying capacity and the piston rods 1a, 2a, the swiveling arms 4, 5, the locking arms 6, 7 and the piston rods 9, 9a connected to the locking arms 6, 7 on either side of the wheel 3 work simultaneously, and not serially as explained in the preceding paragraphs. In this mode of operation the chain lock blocks 8 will be used to retain the chain 3a when the cylinder pistons rods 1a, 2a are being retracted during pulling in and extended during feeding out of the chain, respectively.

Now FIG. 5 is referred to explain the working of the other embodiment. The working principle and functioning, as will be understood to persons skilled in the art remains essentially the same, and those steps are generally not repeated. The main difference is, as explained above, the locking arms 6, 7, which get engaged and disengaged with the notches 6a, 7a on the inner circumferential surface of the sprocket wheel 3. FIG. 5 shows a stage of functioning when both the piston rods 1a, 2a are working in parallel i.e. simultaneously. It shows that both the piston rods 1a 2a have extended to the maximum possible position. However, it should be clear to the persons skilled in the art that these can function alternately i.e. in series one after the other, just like the previous embodiment shown in FIG. 1 to achieve the objects of the invention.

Referring to FIG. 6, the swiveling arms 4, 5 are attached to the piston rods 1a, 2a by one hinge joint 16 and during upward movement of the piston rods 1a, 2a the locking arms 6, 7 engage with the notches 6a, 7a on the inner circumference of the wheel 3. FIG. 6 shows a stage, when such engagements have taken place. Thus, positive movement of the wheel 3 and the chain 3a is ensured.

FIG. 7 shows a stage when the piston rods 1a, 2a have reached their maximum extendable position and have started to retract. Before the retraction of the piston rods 1a, 2a commences, the blocks 8 of the chain lock are brought into engagement with the chain, i.e. the two opposite blocks 8 that are immediately below a chain link which lies in the same plane as the blocks 8, comes to rest with their top surface under the link. The locking arms 6, 7 are now disengaged from the notches 6a, 7a. Now both the piston rods 1a, 2a retract back inside the cylinder, and the piston rods 9a of the arms 4, 5 retracts as well, until the maximum retracted position of the pistons 1a, 2a is reached. In this position the piston rods 9a bring the locking arms 6, 7 into engagement with one of the notches 6a, 7a on either side of the wheel 3. Now, both the pistons 1a, 2a, are again extended to rotate the wheel again.

Thereafter again the maximum extendable positions of the pistons 1a, 2a is reached as shown in FIGS. 5 and 6 and the process of retraction takes place as explained in the preceding paragraph and this process of extending and retracting of the piston rods 1a, 2a is repeated either in parallel on both sides of the wheel, or in series on either side of the wheel, i.e. one after the other.

It should be clear from the FIGS. 6 and 7 that since both the piston rods 1a, 2a are in full stroke (i.e. maximum extendable position) the chain 3a or chain wheel 3 is locked by the chain stopper 8 to prevent rotational movement of the chain 3a or chain wheel 3.

Hence, from the description hereinbefore it would be clear that all the objects of the invention are achieved. The rotation is fast and also it is possible to release the chain by applying a simple mechanism, which functions in a technically perfect manner.

The present invention has been described with reference to two preferred embodiments and some drawings for the sake of understanding only and it should be clear to persons skilled in the art that the present invention includes all legitimate modifications within the ambit of what has been described hereinbefore and claimed in the appended claims.

1. An apparatus for anchoring a floating off-shore unit or other type of floating vessel, comprising:
a rotatably mounted holding device having a traction means secured on its outer periphery, said holding device being arranged to be rotated by reciprocating movement of at least two drive devices;
wherein each of said drive devices is provided with a non-frictional locking means for releasably and mechanically engaging a portion of the holding device in order to rotate the holding device during movement of the respective drive devices.

2. The apparatus according to claim 1, wherein the locking means comprises a swiveling arm, a first end of which is engaged with a top end of the drive device and a second end of which is rotatable about a common axis with the holding device and a locking arm, a first end of which is engaged with the drive device or the swiveling arm, and a second end of which is adapted to engage with one of a multiple of notches or protrusions of the holding device.

3. The apparatus according to claim 1, wherein the second end of each arm is engaged with a bearing arrangement mounted on uprights, which bearing arrangement also carries the holding device in a rotatable manner.

4. The apparatus according to claim 2, wherein the notches or protrusions are located on the outer periphery or an inner periphery of the holding device.

5. The apparatus according to claim 2, wherein the locking arms are equipped with a respective hydraulic cylinder having a piston rod, which can be extended and retracted to bring the locking arm into or out of engagement with the notches or protrusions.

6. The apparatus according to claim 1, wherein the holding device is a sprocket wheel having a geometry for tightly securing along its outer periphery the traction means in the form of a chain.

7. The apparatus according to claim 1, wherein the drive devices are hydraulic cylinders provided with piston rods which can extend and retract by hydraulic means.

8. The apparatus according to claim 7, wherein the hydraulic cylinders are arranged to operate both in series and in parallel for rotation of the sprocket wheel and that one or more chain stoppers (8) are provided near a base of the apparatus, for selectively locking and releasing the chain.

9. A chain stopper for preventing a chain from moving downward, the chain stopper comprising:
at least four blocks that are hinged at their first ends and at their second ends have a surface that is adapted to engage a chain link; and
wherein the blocks are mounted in opposite pairs.

10. The chain stopper according to claim 9, wherein the blocks are situated at a spacing of about 90°, so that the pair of opposite blocks that are immediately below a chain link that lies in substantially the same plane as the blocks will be engaged by the blocks.
